(19) United States
(12) Patent Application Publication
(10) Pub. No.: US 2006/0228625 A1
(43) Pub. Date: Oct. 12, 2006

(54) BATTERY

(76) Inventor: Atsumichi Kawashima, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/278,974

(22) Filed: Apr. 7, 2006

(30) Foreign Application Priority Data
Apr. 8, 2005 (JP) 2005-112051

(51) Int. Cl. H01M 10/40

(52) U.S. Cl. 429/200; 429/330

(57) ABSTRACT

A battery capable of improving cycle characteristics is provided. A cathode and an anode are oppositely arranged with a separator in between. An electrolytic solution is impregnated in the separator. The electrolytic solution contains a derivative of cyclic carbonate having halogen atoms such as 4-fluoro-1,3-dioxolane-2-one and 4-chloro-1,3-dioxolane-2-one; and a cyclic acid anhydride such as succinic anhydride. The anode has an anode current collector and an anode active material layer which is provided on the anode current collect and is alloyed with the anode current collector at least at part of the interface with the anode current collector

### CROSS REFERENCES TO RELATED APPLICATIONS

The present invention contains subject matter related to Japanese Patent Application JP 2005-112051 filed in the Japanese Patent Office on Apr. 8, 2005, the entire contents of which being incorporated herein by reference.

### BACKGROUND OF THE INVENTION

1. Field of the Invention

The present invention relates to a battery using a derivative of cyclic carbonate having halogen atoms.

2. Description of the Related Art

In recent years, many portable electronic devices such as combination cameras (videotape recorder), digital still cameras, mobile phones, personal digital assistance, and notebook computers have been introduced, and their size and weight have been reduced. Accordingly, as a portable power source for the electronic devices, for batteries, in particular, secondary batteries, research and development for improving the energy density have been actively promoted. Specially, lithium ion secondary batteries in which a carbon material is used for the anode, a composite material of lithium and transition metals is used for the cathode, and ester carbonate is used for the electrolytic solution have been practically used widely, since such lithium ion secondary batteries can provide a higher energy density compared to traditional lead batteries and nickel cadmium batteries.

Further, recently, as portable electronic devices have been sophisticated, further improvement of the capacity has been demanded. Therefore, it is considered to use tin (Sn), silicon (Si) or the like instead of a carbon material as an anode active material. The theoretical capacity of tin is 994 mAh/g, and the theoretical capacity of silicon is 4199 mAh/g. Such capacities are significantly larger than the theoretical capacity of graphite, 372 mAh/g, and thereby the capacity is expected to be improved. In particular, it has been reported that in the anode in which a thin film of tin or silicon is formed on the current collector, the anode active material is not pulverized due to insertion and extraction of lithium, and a relatively high discharge capacity can be retained (for example, refer to International Publication No. WO01/031724).

### SUMMARY OF THE INVENTION

However, a tin alloy or a silicon alloy, which inserts lithium (Li), has high activity. Therefore, there has been a disadvantage that when ester carbonate and the like traditionally used for the electrolytic solution are utilized, such ester carbonate and the like are decomposed and lithium is inactivated. Therefore, it is considered to inhibit decomposition reaction of the solvent in the anode and improve cycle characteristics by using a derivative of cyclic carbonate having halogen atoms for the electrolytic solution. However, effect to inhibit decomposition reaction of the electrolytic solution has not been sufficient, and further improvement of the cycle characteristics has been desired.

In view of such a disadvantage, in the present invention, it is desirable to provide a battery capable of improving the cycle characteristics.

According to an embodiment of the present invention, there is provided a battery including a cathode, an anode, and an electrolytic solution, in which the anode has an anode current collector and an anode active material layer which is provided on the anode current collector and is alloyed with the anode current collector at least at part of the interface with the anode current collector, and the electrolytic solution contains a derivative of cyclic carbonate having halogen atoms and a cyclic acid anhydride.

According to an embodiment of the present invention, there is provided another battery including a cathode, an anode, and an electrolytic solution in which the anode has an anode current collector and an anode active material layer formed on the anode current collector by at least one from the group consisting of vapor-phase deposition method, liquid-phase deposition method and firing method, and the electrolytic solution contains a derivative of cyclic carbonate having halogen atoms and a cyclic acid anhydride.

According to the battery or another battery of the embodiment of the present invention, the electrolytic solution contains a derivative of cyclic carbonate having halogen atoms and the cyclic acid anhydride. Therefore, decomposition reaction of the electrolytic solution can be inhibited, and cycle characteristics can be improved.

In particular, when the content of the cyclic acid anhydride in the electrolytic solution is in the range from 0.1 wt % to 2.5 wt %, the cycle characteristics can be further improved.

Other and further objects, features and advantages of the invention will appear more fully from the following description.

### BRIEF DESCRIPTION OF THE DRAWINGS

FIG. 1 is a cross section showing a structure of a secondary battery according to a first embodiment of the present invention;

FIG. 2 is a cross section showing a structure of a secondary battery according to a second embodiment of the present invention; and

FIG. 3 is a cross section showing a structure taken along line I-I of a spirally wound electrode body shown in FIG. 2.

### DETAILED DESCRIPTION OF THE PREFERRED EMBODIMENTS

Embodiments of the present invention will be hereinafter described in detail with reference to the drawings.

### First Embodiment

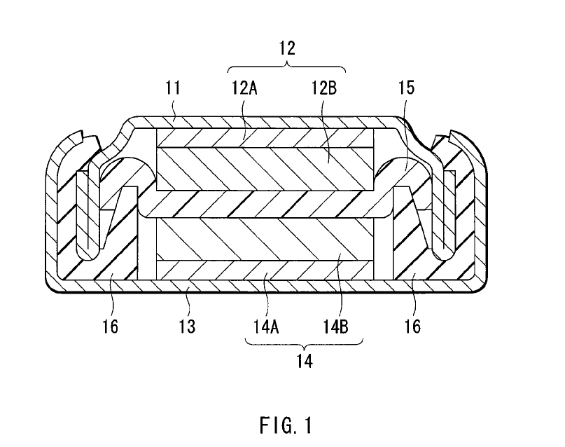

FIG. 1 shows a structure of a secondary battery according to a first embodiment of the present invention. The secondary battery is a so-called coin-type secondary battery in which an anode 12 contained in a package cup 11 and a cathode 14 contained in a package can 13 are layered with a separator 15 impregnated with an electrolytic solution in between. Peripheral edges of the package cup 11 and the package can 13 are hermetically sealed by being caulked with an insulating gasket 16. The package cup 11 and the package can 13 are respectively made of a metal such as stainless and aluminum (Al).

The anode 12 has, for example, an anode current collector 12A and an anode active material layer 12B provided on the anode current collector 12A. The anode active material layer 12B may be provided on the both faces or one face of the anode current collector 12A.

The anode current collector 12A is preferably made of a metal material containing at least one metal element not forming an intermetallic compound with lithium. When the intermetallic compound is formed with lithium, the anode is expanded and shrunk due to charge and discharge, structural destruction occurs, and current collectivity is lowered. In addition, ability to support the anode active material layer 12 is lowered. In the specification, the metal material includes an alloy including two or more metal elements or an alloy including one or more metal elements and one or more metalloid elements in addition to simple substances of metal elements. As a metal element not forming an intermetallic compound with lithium, for example, copper (Cu), nickel (Ni), titanium (Ti), iron (Fe), or chromium (Cr) can be cited.

The anode current collector 12A preferably contains a metal element to be alloyed with the anode active material layer 12B, since thereby contact characteristics between the anode active material layer 12B and the anode current collector 12A can be improved. As a metal element, which does not form an intermetallic compound with lithium and is alloyed with the anode active material layer 12B, for example, as described later, when the anode active material layer 12B contains silicon, tin or the like as an element, copper, nickel, or iron can be cited. These metal elements are preferable in view of strength and electrical conductivity.

The anode current collector 12A may be composed of a single layer or a plurality of layers. Further, the surface roughness of the anode current collector 12A is preferably 0.1 μm or more in arithmetic mean roughness Ra. Thereby, stress generated by expansion and shrinkage of the anode active material layer 12B due to charge and discharge is dispersed and structural destruction of the anode 12 can be inhibited.

The anode active material layer 12B contains, for example, an anode active material containing at least one from the group consisting of metal elements and metalloid elements capable of forming an alloy with lithium as an element. Specially, at least one of silicon and tin is preferably contained as an element. Silicon and tin have a high ability to insert and extract lithium, and provide a high energy density. These metal elements and metalloid elements may be contained in the form of a simple substance, an alloy, or a compound.

As an alloy or a compound of silicon, for example, SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), or LiSiO can be cited. As a compound or an alloy of tin, for example, an alloy of tin and an element included in Groups 4 to 11 in the long period periodic table can be cited. In addition, Mg₂Sn, SnO_{w} (0<w≦2), SnSiO₃, or LiSnO can be cited.

The anode active material layer 12B is preferably formed by at least one method from the group consisting of vapor-phase deposition method, liquid-phase deposition method, and firing method. Thereby, destruction due to expansion and shrinkage of the anode active material layer 12B in accordance with charge and discharge can be inhibited, and electron conductivity in the anode active material layer 12B can be improved. Further, a binder, void and the like can be decreased or excluded, and the anode 12 can become a thin film. In the specification, the words, “forming the active material layer by firing method” means that powder containing an active material and a binder are mixed to form a layer, which is heat-treated, and thereby a layer which has a higher volume density and is denser compared to before heat treatment is formed.

The anode active material layer 12B is further preferably alloyed with the anode current collector layer 12A at the interface with the anode current collector 12A at least in part. Specifically, it is preferable that at the interface thereof, the element of the anode current collector 12A is diffused in the anode active material layer 12B, or the element of the anode active material layer 12B is diffused in the anode current collector 12A, or both elements are diffused therein. Thereby, the contact characteristics with the anode current collector 12A can be improved. The alloying often occurs concurrently with forming the anode active material layer 12B by vapor-phase deposition method, liquid-phase deposition method, or firing method. Otherwise, the alloying may be generated by heat treatment, or may occur in the initial charge. In the specification, diffusion of elements described above is one of the forms of alloying.

The cathode 14 has, for example, a cathode current collector 14A and a cathode active material layer 14B provided on the cathode current collector 14A. Arrangement is made so that the cathode active material layer 14B side is opposed to the anode active material layer 12B. The cathode current collector 14A is made of, for example, aluminum, nickel, stainless or the like.

The cathode active material layer 14B contains, for example, as a cathode active material, one or more cathode materials capable of inserting and extracting lithium. The cathode active material layer 14B may contain an electrical conductor such as a carbon material and a binder such as polyvinylidene fluoride according to needs. As a cathode material capable of inserting and extracting lithium, for example, a lithium-containing metal complex oxide expressed by a general formula, LiₓMIO₂ is preferable, since the lithium-containing metal complex oxide can generate a high voltage and has a high density, which allows a further high capacity of the secondary battery. MI represents one or more transition metals, and preferably at least one of cobalt and nickel, for example. x varies according to charge and discharge states of the battery, and is generally in the range of 0.05≦x≦1.10. As a specific example of such a lithium-containing metal complex oxide, LiCoO₂, LiNiO₂ or the like can be cited.

The separator 15 separates the anode 12 from the cathode 14, prevents current short circuit due to contact of the both electrodes, and lets through lithium ions. The separator 15 is made of, for example, polyethylene or polypropylene.

An electrolytic solution impregnated in the separator 15 contains, for example, a solvent and an electrolyte salt dissolved in the solvent.

The solvent contains a high dielectric constant solvent with a specific inductive capacity of 30 or more. Thereby, the number of lithium ions can be increased.

The high dielectric constant solvent contains a derivative of cyclic carbonate having halogen atoms, since thereby decomposition reaction of the solvent can be inhibited. Specific examples of such a derivative of cyclic carbonate include 4-fluoro-1,3-dioxolane-2-one shown in Chemical formula 1-1, 4-difluoro-1,3-dioxolane-2-one, 4,5-difluoro-1,3-dioxolane-2-one, 4-difluoro-5-fluoro-1,3-dioxolane-2-one, 4-fluoromethyl-1,3-dioxolane-2-one, 4-trifluoromethyl-1,3-dioxolane-2-one, 4-chloro-1,3-dioxolane-2-one shown in Chemical formula 1-2, and 4,5-dichloro-1,3-dioxolane-2-one. Specially, 4-fluoro-1,3-dioxolane-2-one or 4-chloro-1,3-dioxolane-2-one is preferable, and in particular, 4-fluoro-1,3-dioxolane-2-one is desirable, since thereby higher effect can be obtained. One of the derivatives of cyclic carbonate can be used singly, or a plurality thereof can be used by mixing.

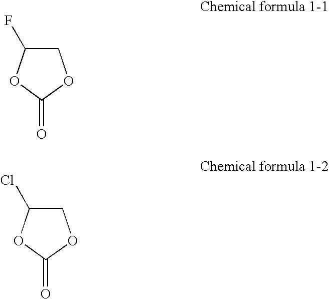

As a high dielectric constant solvent, other high dielectric constant solvent may be mixed with the foregoing derivative of cyclic carbonate. As other high dielectric constant solvent, for example, cyclic carbonate such as ethylene carbonate, propylene carbonate, butylene carbonate, vinylene carbonate, and vinyl ethylene carbonate; lactone such as γ-butyrolactone and γ-valerolactone; lactam such as N-methyl-2-pyrrolidone; cyclic carbamic ester such as N-methyl-2-oxazolidinone; or a sulfone compound such as tetramethylene sulfone can be cited. One of other high dielectric constant solvents may be used singly, or a plurality thereof may be used by mixing.

Further, it is preferable to mix a low-viscosity solvent having a viscosity of 1 mPa·s or less with the high dielectric constant solvent. Thereby, high ion conductivity can be obtained. As a low-viscosity solvent, for example, chain ester carbonate such as dimethyl carbonate, diethyl carbonate, and ethyl methyl carbonate; chain carboxylate ester such as methyl acetate, ethyl acetate, methyl propionate, ethyl propionate, methyl butyrate, methyl isobutyrate, methyl trimethylacetate, and ethyl trimethylacetate; chain amide such as N,N-dimethylacetamide; chain carbamic acid ester such as N,N-methyl diethylcarbamate and N,N-ethyl diethylcarbamate; ether such as 1,2-dimethoxyethane, tetrahydrofuran, tetrahydropyran, and 1,3-dioxolane can be cited. One of the low-viscosity solvents may be used singly, or a plurality thereof may be used by mixing.

As an electrolyte salt, for example, an inorganic lithium salt such as lithium hexafluorophosphate (LiPF₆), lithium borate tetrafluoride (LiBF₄), lithium arsenate hexafluoride (LiAsF₆), lithium hexafluoroantimonate (LiSbF₆), lithium perchlorate (LiClO₄), and lithium aluminum acid tetrachloride (LiAlCl₄); a lithium salt of a perfluoroalkanesulfonate derivative such as lithium trifluoromethanesulfonate (CF₃SO₃Li), lithium bis(trifluoromethanesulfone)imide ((CF₃SO₂)₂NLi), lithium bis(pentafluoroethanesulfone)imide (C₂F₅SO₂)₂NLi), and lithium tris(trifluoromethanesulfone)methide ((CF₃SO₂)₃CLi) can be cited. One electrolyte salt may be used singly, or a plurality thereof may be used by mixing.

The electrolytic solution further contains a cyclic acid anhydride as an additive. Thereby, decomposition reaction of the electrolytic solution can be further inhibited.

As a cyclic acid anhydride, for example, a compound formed from carboxylic acid-carboxylic acid, a compound formed from carboxylic acid-sulfonic acid, or a compound formed from sulfonic acid-sulfonic acid can be cited.

Specific examples of the cyclic acid anhydride include succinic anhydride shown in Chemical formula 2-1, glutaric anhydride shown in Chemical 2-2, maleic anhydride shown in Chemical formula 2-3, phthalic anhydride shown in Chemical formula 2-4, 2-sulfobenzoic anhydride shown in Chemical formula 2-5, citraconic anhydride shown in Chemical formula 2-6, itaconic anhydride shown in Chemical formula 2-7, diglycolic anhydride shown in Chemical formula 2-8, hexafluoro glutaric anhydride shown in Chemical formula 2-9, phthalic anhydride derivative such as 3-fluoro phthalic anhydride shown in Chemical formula 2-10 and 4-fluoro phthalic anhydride shown in Chemical formula 2-11, 3,6-epoxy-1,2,3,6-tetrahydro phthalic anhydride shown in Chemical formula 2-12, 1,8-naphthalic anhydride shown in Chemical formula 2-13, 2,3-naphthalene carboxylic anhydride shown in Chemical formula 2-14, 1,2-cycloalkane dicarboxylic anhydride such as 1,2-cyclopentane dicarboxylic anhydride and 1,2-cyclohexane dicarboxylic anhydride, 1,2-cycloalkene dicarboxylic acid such as 1,2,3,6-tetrahydro phthalic anhydride and 3,4,5,6-tetrahydro phthalic anhydride, and pyromelletic dianhydride.

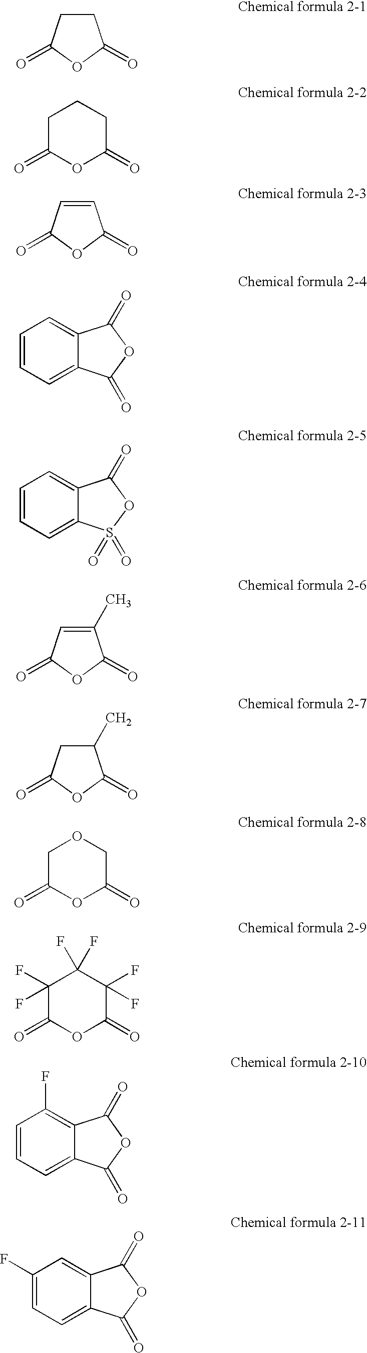

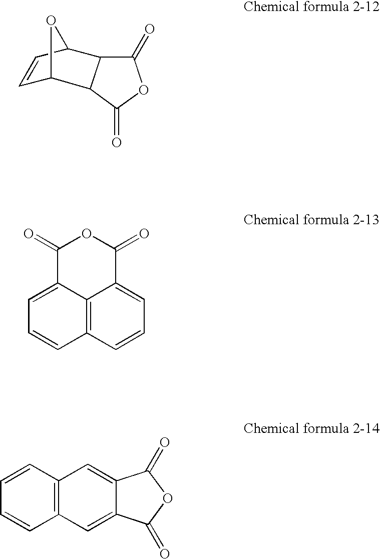

The content of the foregoing cyclic acid anhydride is preferably in the range from 0.1 wt % to 2.5 wt % to the whole electrolytic solution. In such a range, high effect can be obtained.

The secondary battery can be manufactured, for example, as follows.

First, for example, the anode current collector 12A made of a metal foil is prepared. The anode active material layer 12B is formed on the anode current collector 12A by vapor-phase deposition method or liquid-phase deposition method. Otherwise, it is possible that a precursor layer containing a particulate anode active material is formed on the current collector 12A, and then the resultant is fired and thereby the anode active material layer 12B is formed. Otherwise, the anode active material layer 12B may be formed by combining two or three methods of vapor-phase deposition method, liquid-phase deposition method, and firing method.

As vapor-phase deposition method, for example, physical deposition method or chemical deposition method can be cited. Specifically, vacuum vapor deposition method, sputtering method, ion plating method, laser ablation method, CVD (Chemical Vapor Deposition) method and the like can be cited. As liquid-phase deposition method, a known technique such as electrolytic plating and electroless plating is available. For firing method, a known technique such as atmosphere firing method, reactive firing method, and hot press firing method is available.

Next, if necessary, heat treatment is preferably provided under the vacuum atmosphere or under the non-oxidizing atmosphere. In some cases, at least part of the interface between the anode active material layer 12B and the anode current collector 12A is alloyed when the anode active material layer 12B is formed. However, alloying can be further promoted by providing heat treatment.

Further, the cathode 14 is formed by forming the cathode active material layer 14B on the cathode current collector 14A. The cathode active material layer 14B is formed by, for example, dispersing a cathode active material, an electrical conductor, and a binder in a disperse medium, coating the cathode current collector 14A with the resultant, volatilizing the disperse medium, and then compression-molding the resultant.

Next, for example, the anode 12, the separator 15 impregnated with the electrolytic solution, and the cathode 14 are layered, the lamination is inserted in the package cup 11 and the exterior can 13, which are caulked. Thereby, the secondary battery shown in FIG. 1 is obtained.

In the secondary battery, when charged, for example, lithium ions are extracted from the cathode 14 and inserted in the anode 12 through the electrolytic solution. When discharged, for example, lithium ions are extracted from the anode 12, and inserted in the cathode 14 through the electrolytic solution. Then, since the derivative of cyclic carbonate having halogen atoms and the cyclic acid anhydride are contained in the electrolytic solution, decomposition reaction of the electrolytic solution can be inhibited.

As above, according to this embodiment, since the derivative of cyclic carbonate having halogen atoms and the cyclic acid anhydride are contained in the electrolytic solution, decomposition reaction of the electrolytic solution can be inhibited, and the cycle characteristics can be improved.

In particular, when the content of the cyclic acid anhydride in the electrolytic solution is in the range from 0.1 wt % to 2.5 wt %, the cycle characteristics can be further improved.

### Second Embodiment

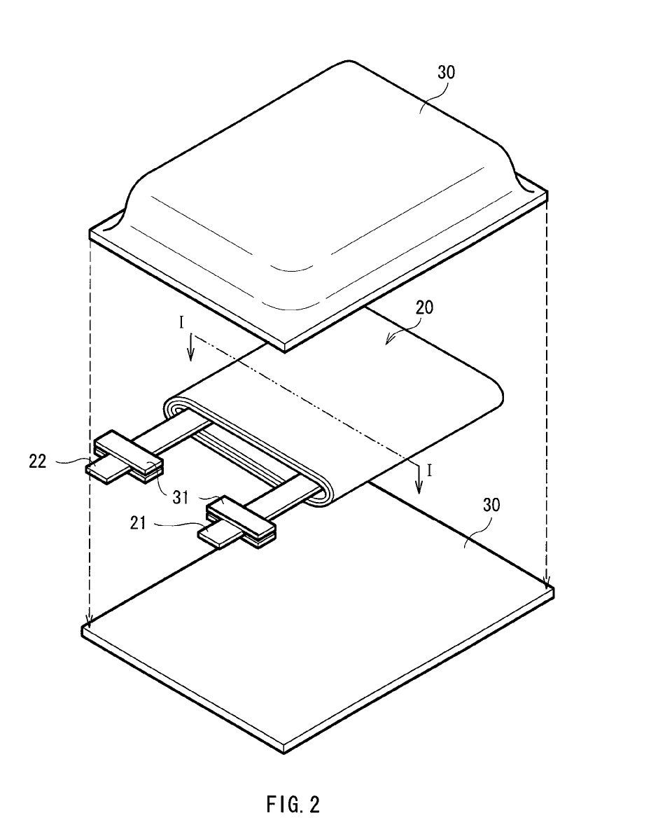

FIG. 2 shows a structure of a secondary battery according to a second embodiment of the present invention. In the secondary battery, a spirally wound electrode body 20 on which leads 21 and 22 are attached is contained inside a film package member 30. Thereby, the size, the weight, and the thickness can be reduced.

The leads 21 and 22 are respectively directed from inside to outside of the package member 30 in the same direction, for example. The leads 21 and 22 are respectively made of, for example, a metal material such as aluminum, copper, nickel, and stainless, and are in the shape of thin plate or mesh.

The package member 30 is made of a rectangular aluminum laminated film in which, for example, a nylon film, an aluminum foil, and a polyethylene film are bonded together in this order. The package member 30 is, for example, arranged so that the polyethylene film side and the spirally wound electrode body 20 are opposed, and the respective outer edges are contacted to each other by fusion bonding or an adhesive. Adhesive films 31 to protect from outside air intrusion are inserted between the package member 30 and the leads 21, 22. The adhesive film 31 is made of a material having contact characteristics to the leads 21 and 22, for example, is made of a polyolefin resin such as polyethylene, polypropylene, modified polyethylene, and modified polypropylene.

The exterior member 30 may be made of a laminated film having other structure, a high molecular weight film such as polypropylene, or a metal film, instead of the foregoing aluminum laminated film.

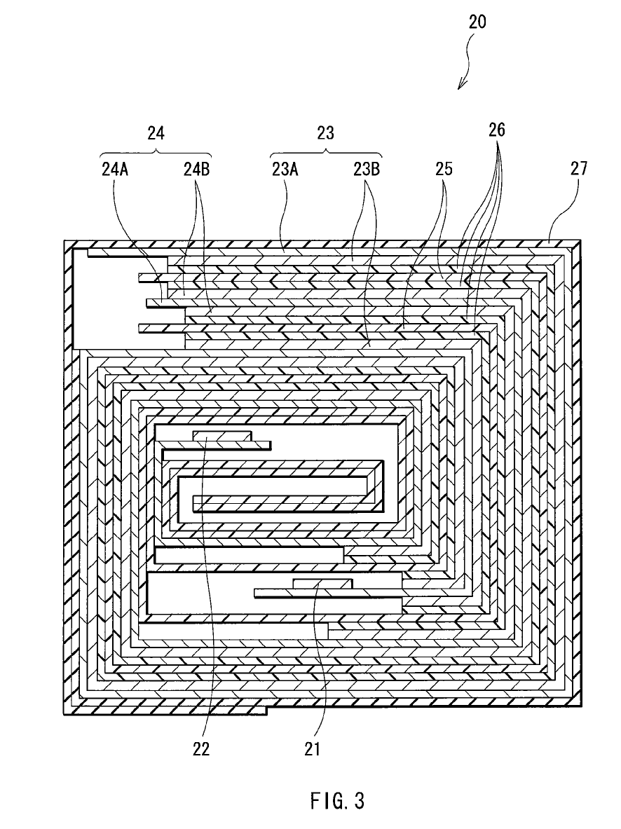

FIG. 3 shows a cross sectional structure taken along line I-I of the spirally wound electrode body 20 shown in FIG. 2. In the spirally wound electrode body 20, an anode 23 and a cathode 24 are layered with a separator 25 and an electrolyte layer 26 in between and wound. The outermost periphery thereof is protected by a protective tape 27.

The anode 23 has a structure in which an anode active material layer 23B is provided on the both faces of an anode current collector 23A. The cathode 24 has a structure in which a cathode active material layer 24B is provided on the both faces of a cathode current collector 24A. Arrangement is made so that the cathode active material layer 24B is opposed to the anode active material layer 23B. The specific structures of the anode current collector 23A, the anode active material layer 23B, the cathode current collector 24A, the cathode active material layer 24B, and the separator 25 are similar to of the anode current collector 12A, the anode active material layer 12B, the cathode current collector 14A, the cathode active material layer 14B, and the separator 15 in the first embodiment.

The electrolyte layer 26 is made of a so-called gelatinous electrolyte in which an electrolytic solution is held in a high molecular weight compound. The gelatinous electrolyte is preferable, since high ion conductivity can be obtained and liquid leakage of the battery can be prevented. The structure of the electrolytic solution is similar to of the first embodiment. As a high molecular weight material, for example, polyacrylonitrile, polyvinylidene fluoride, a copolymer of vinylidene fluoride and hexafluoropropylene, polyethylene oxide or the like can be cited.

The secondary battery can be manufactured, for example, as follows.

First, the electrolyte layer 26 in which an electrolytic solution is held in a high molecular weight compound is formed on the anode 23 and the cathode 24, respectively. After that, the lead 21 is attached to the end of the anode current collector 23A, and the lead 22 is attached to the end of the cathode current collector 24A. Next, the anode 23 and the cathode 24 formed with the electrolyte layer 26 are layered with the separator 25 in between to obtain a lamination. After that, the lamination is wound in the longitudinal direction, and the protective tape 27 is adhered to the outermost periphery thereof to form the spirally wound electrode body 20. Finally, for example, the spirally wound electrode body 20 is sandwiched between the package members 30, and outer edges of the exterior members 30 are contacted by thermal fusion bonding or the like to enclose the spirally wound electrode body 20. Then, the adhesive films 31 are inserted between the leads 21, 22 and the exterior member 30. Thereby, the secondary battery shown in FIGS. 2 and 3 is completed.

The secondary battery works in the same manner as in the first embodiment, and has effect similar to of the first embodiment.

### EXAMPLES

Further, specific examples of the present invention will be described in detail.

### Examples 1-1 to 1-15

The coin-type secondary battery shown in FIG. 1 was fabricated. First, the anode active material layer 12B made of silicon being 5 μm thick was formed on the anode current collector 12A made of a copper foil being 15 μm thick by sputtering method. After that, the anode current collector 12A formed with the anode active material layer 12B was punched out into a circular form being 16 mm in diameter, and the anode 12 was formed.

Further, as a cathode active material, 94 parts by weight of lithium-cobalt complex oxide (LiCoO₂), 3 parts by weight of graphite as an electrical conductor, and 3 parts by weight of polyvinylidene fluoride as a binder were mixed. The mixture was added with N-methyl-2-pyrrolidone as a solvent to obtain cathode mixture slurry. Next, the cathode current collector 14A made of an aluminum foil being 20 μm thick was uniformly coated with the obtained cathode mixture slurry, which was dried to form the cathode active material layer 14B being 70 μm thick. After that, the cathode current collector 14A formed with the cathode active material layer 14B was punched out in a circle being 15 mm in diameter to form the cathode 14.

Next, the anode 12 and the cathode 14 were layered with the separator 15 made of a microporous polypropylene film being 25 μm thick in between. After that, 0.1 g of the electrolytic solution was injected in the separator 15. The resultant was inserted in the package cup 11 and the package can 13 made of stainless, which were caulked. Thereby, the secondary battery shown in FIG. 1 was obtained. The electrolytic solution was prepared as follows. A derivative of cyclic carbonate having halogen atoms as a high dielectric constant solvent, dimethyl carbonate as a low-viscosity solvent, and lithium hexafluorophosphate as an electrolyte salt were mixed at a weight ratio of derivative of cyclic carbonate:dimethyl carbonate:lithium hexafluorophosphate=42:42:16. Further, as an additive, a cyclic acid anhydride was added to the mixture so that the content of the cyclic acid anhydride became 1 wt %. Then, for the derivative of cyclic carbonate, 4-chloro-1,3-dioxolane-2-one was used in Example 1-1, and 4-fluoro-1,3-dioxolane-2-one was used in Examples 1-2 to 1-15. For the cyclic acid anhydride, succinic anhydride was used in Examples 1-1 and 1-2, glutaric anhydride was used in Example 1-3, maleic anhydride was used in Example 1-4, phthalic anhydride was used in Example 1-5, 2-sulfobenzoic anhydride was used in Example 1-6, citraconic anhydride was used in Example 1-7, itaconic anhydride was used in Example 1-8, diglycolic anhydride was used in Example 1-9, hexafluoro glutaric anhydride was used in Example 1-10, 3-fluoro phthalic anhydride was used in Example 1-11, 4-fluoro phthalic anhydride was used in Example 1-12, 3,6-epoxy-1,2,3,6-tetrahydro phthalic anhydride was used in Example 1-13, 1,8-naphthalic anhydride was used in Example 1-14, and 2,3-naphthalene carboxylic anhydride was used in Example 1-15.

As Comparative examples 1-1 and 1-2 relative to Examples 1-1 to 1-15, secondary batteries were fabricated in the same manner as in Examples 1-1 to 1-15, except that 4-chloro-1,3-dioxolane-2-one or 4-fluoro-1,3-dioxolane-2-one was used as a high dielectric constant solvent, and an additive was not added. Further, as Comparative example 1-3, a secondary battery was fabricated in the same manner as in Examples 1-1 to 1-15, except that ethylene carbonate was used as a high dielectric constant solvent, and succinic anhydride was used as an additive.

For the obtained secondary batteries of Examples 1-1 to 1-15 and Comparative examples 1-1 to 1-3, charge and discharge, in which charge at 1.77 mA was performed for 12 hours up to the upper limit of 4.2 V, the battery was left for 10 minute recess, and discharge at 1.77 mA was performed until reaching 2.5 V, were repeated. Then, the discharge capacity retention ratio at the 50th cycle was obtained. The discharge capacity retention ratio at the 50th cycle was calculated as (discharge capacity at the 50th cycle/initial discharge capacity)×100(%). The results are shown in Table 1.

TABLE 1

| | | | | Discharge |
|---|---|---|---|---|
| | Anode | | | capacity |
| | active | High dielectric | | retention |
| | material | constant solvent | Cyclic acid anhydride | ratio (%) |
| Example 1-1 | Si | CIEC | Succinic anhydride | 82.3 |
| Example 1-2 | | FEC | Succinic anhydride | 89.1 |
| Example 1-3 | | | Glutaric anhydride | 89.7 |
| Example 1-4 | | | Maleic anhydride | 89.6 |
| Example 1-5 | | | Phthalic anhydride | 91.7 |
| Example 1-6 | | | 2-sulfobenzoic anhydride | 89.6 |
| Example 1-7 | | | Citraconic anhydride | 88.0 |
| Example 1-8 | | | Itaconic anhydride | 93.1 |
| Example 1-9 | | | Diglycolic anhydride | 91.5 |
| Example 1-10 | | | Hexafluoro glutaric | 91.7 |
| | | | anhydride | |
| Example 1-11 | | | 3-fluoro phthalic anhydride | 90.0 |
| Example 1-12 | | | 4-fluoro phthalic anhydride | 90.1 |
| Example 1-13 | | | 3,6-epoxy-1,2,3,6-tetrahydro | 88.7 |
| | | | phthalic anhydride | |
| Example 1-14 | | | 1,8-naphthalic anhydride | 88.0 |
| Example 1-15 | | | 2,3-naphthalene carboxylic | 89.8 |
| | | | anhydride | |
| Comparative | Si | CIEC | Not added | 68.5 |
| example 1-1 | | | | |
| Comparative | | FEC | Not added | 75.7 |
| example 1-2 | | | | |
| Comparative | | Ethylene | Succinic anhydride | 47.0 |
| example 1-3 | | carbonate | | |

CIEC: 4-chloro-1,3-dioxolane-2-one
FEC: 4-fluoro-1,3-dioxolane-2-one

As evidenced by Table 1, according to Example 1-1 using 4-chloro-1,3-dioxolane-2-one and the cyclic acid anhydride or Examples 1-2 to 1-15 using 4-fluoro-1,3-dioxolane-2-one and the cyclic acid anhydride, higher values for the discharge capacity retention ratio could be respectively obtained compared to in Comparative example 1-1 or Comparative example 1-2 not using a cyclic acid anhydride, and further, higher discharge capacity retention ratios could be obtained compared to in Comparative example 1-3 not using 4-chloro-1,3-dioxolane-2-one or 4-fluoro-1,3-dioxolane-2-one.

That is, it was found that when the derivative of cyclic carbonate having halogen atoms and the cyclic acid anhydride were contained in the electrolytic solution, cycle characteristics could be improved.

### Examples 2-1 to 2-15

Coin-type secondary batteries were fabricated in the same manner as in Examples 1-1 to 1-15, except that tin was used for the anode active material, and the anode active material layer 12B made of tin being 5 μm thick was formed on the anode current collector 12A made of a copper foil being 15 μm thick by vapor deposition method.

As Comparative examples 2-1 to 2-3 relative to Examples 2-1 to 2-15, secondary batteries were fabricated in the same manner as in Examples 2-1 to 2-15, except that 4-chloro-1,3-dioxolane-2-one or 4-fluoro-1,3-dioxolane-2-one was not used, or an additive was not added, that is, except that an electrolytic solution similar to of Comparative examples 1-1 to 1-3 was used.

For the obtained secondary batteries of Examples 2-1 to 2-15 and Comparative examples 2-1 to 2-3, the discharge capacity retention ratio at the 50th cycle was obtained in the same manner as in Examples 1-1 to 1-15. The results are shown in Table 2.

TABLE 2

| | | | | Discharge |
|---|---|---|---|---|
| | Anode | | | capacity |
| | active | High dielectric | | retention |
| | material | constant solvent | Cyclic acid anhydride | ratio (%) |
| Example 2-1 | Sn | CIEC | Succinic anhydride | 84.4 |
| Example 2-2 | | FEC | Succinic anhydride | 91.3 |
| Example 2-3 | | | Glutaric anhydride | 92.0 |
| Example 2-4 | | | Maleic anhydride | 91.9 |
| Example 2-5 | | | Phthalic anhydride | 94.0 |
| Example 2-6 | | | 2-sulfobenzoic anhydride | 91.9 |
| Example 2-7 | | | Citraconic anhydride | 90.2 |
| Example 2-8 | | | Itaconic anhydride | 95.5 |
| Example 2-9 | | | Diglycolic anhydride | 93.8 |
| Example 2-10 | | | Hexafluoro glutaric | 94.0 |
| | | | anhydride | |
| Example 2-11 | | | 3-fluoro phthalic anhydride | 92.3 |
| Example 2-12 | | | 4-fluoro phthalic anhydride | 92.4 |
| Example 2-13 | | | 3,6-epoxy-1,2,3,6-tetrahydro | 91.0 |
| | | | phthalic anhydride | |
| Example 2-14 | | | 1,8-naphthalic anhydride | 90.2 |
| Example 2-15 | | | 2,3-naphthalene carboxylic | 92.1 |
| | | | anhydride | |
| Comparative | Sn | CIEC | Not added | 70.2 |
| example 2-1 | | | | |
| Comparative | | FEC | Not added | 77.6 |
| example 2-2 | | | | |
| Comparative | | Ethylene | Succinic anhydride | 49.4 |
| example 2-3 | | carbonate | | |

CIEC: 4-chloro-1,3-dioxolane-2-one
FEC: 4-fluoro-1,3-dioxolane-2-one

As evidenced by Table 2, similarly to in Examples 1-1 to 1-15, according to Example 2-1 using 4-chloro-1,3-dioxolane-2-one and the cyclic acid anhydride or Examples 2-2 to 2-15 using 4-fluoro-1,3-dioxolane-2-one and the cyclic acid anhydride, higher values for the discharge capacity retention ratio could be respectively obtained compared to in Comparative example 2-1 or Comparative example 2-2 not using a cyclic acid anhydride, and further, higher discharge capacity retention ratios could be obtained compared to in Comparative example 2-3 not using 4-chloro-1,3-dioxolane-2-one or 4-fluoro-1,3-dioxolane-2-one.

That is, it was found that even when other anode active material was used, cycle characteristics could be improved as long as the derivative of cyclic carbonate having halogen atoms and the cyclic acid anhydride were contained in the electrolytic solution.

### Examples 3-1 to 3-3 and 4-1 to 4-3

Secondary batteries were fabricated in the same manner as in Examples 1-2 and 2-2, except that the content of succinic anhydride in the electrolytic solution was changed to 2.5 wt %, 2.0 wt %, or 0.1 wt %.

For the secondary batteries of Examples 3-1 to 3-3 and 4-1 to 4-3, the discharge capacity retention ratio at the 50th cycle was obtained in the same manner as in Examples 1-1 to 1-15. The results are shown together with the results of Examples 1-2 and 2-2, and Comparative examples 1-2 and 2-2 in Tables 3 and 4.

TABLE 3

| | | High | | | Discharge |
|---|---|---|---|---|---|
| | Anode | dielectric | Cyclic acid anhydride | | capacity |
| | active | constant | | Content | retention |
| | material | solvent | Kind | (wt %) | ratio (%) |
| Example 3-1 | Si | FEC | Succinic | 2.5 | 76.1 |
| Example 3-2 | | | anhydride | 2.0 | 76.7 |
| Example 1-2 | | | | 1.0 | 89.1 |
| Example 3-3 | | | | 0.1 | 77.8 |
| Comparative | Si | FEC | Not added | 0 | 75.7 |
| example 1-2 | | | | | |

FEC: 4-fluoro-1,3-dioxolane-2-one

TABLE 4

| | | High | | | Discharge |
|---|---|---|---|---|---|
| | Anode | dielectric | Cyclic acid anhydride | | capacity |
| | active | constant | | Content | retention |
| | material | solvent | Kind | (wt %) | ratio (%) |
| Example 4-1 | Sn | FEC | Succinic | 2.5 | 78.0 |
| Example 4-2 | | | anhydride | 2.0 | 79.8 |
| Example 2-2 | | | | 1.0 | 91.3 |
| Example 4-3 | | | | 0.1 | 81.8 |
| Comparative | Sn | FEC | Not added | 0 | 77.6 |
| example 2-2 | | | | | |

FEC: 4-fluoro-1,3-dioxolane-2-one

As evidenced by Tables 3 and 4, there was a tendency that as the content of succinic anhydride in the electrolytic solution was increased, the discharge capacity retention ratio was increased, showed the maximum value, and then was decreased.

That is, it was found that the content of the cyclic acid anhydride in the electrolytic solution was preferably in the range from 0.1 wt % to 2.5 wt %.

The present invention has been described with reference to the embodiments and the examples. However, the present invention is not limited to the embodiments and the examples, and various modifications may be made. For example, in the foregoing embodiments and the foregoing examples, descriptions have been given of the case using the electrolytic solution or the gelatinous electrolyte in which an electrolytic solution is held in a high molecular weight compound as an electrolyte. However, other electrolyte may be used. As other electrolyte, for example, a mixture of an ion conductive inorganic compound such as ion conductive ceramics, ion conductive glass, and ionic crystal and an electrolytic solution; a mixture of other inorganic compound and an electrolytic solution; or a mixture of the foregoing inorganic compound and a gelatinous electrolyte can be cited.

Further, in the foregoing embodiments and the foregoing examples, descriptions have been given with specific examples of the coin-type or laminated film-type secondary battery. However, the present invention can be similarly applied to a secondary battery having other shape such as a button-type, cylindrical-type, square-type, thin-type, or large-sized secondary battery, or a secondary battery having other structure such as a laminated structure. Further, the present invention can be applied to other batteries such as primary batteries in addition to the secondary batteries.

It should be understood by those skilled in the art that various modifications, combinations, sub-combinations and alternations may occur depending on design requirements and other factors insofar as they are within the scope of the appended claims or the equivalents thereof.

What is claimed is:

1. A battery comprising:
a cathode;
an anode; and
an electrolytic solution,
wherein the anode has an anode current collector and an anode active material layer which is provided on the anode current collector and is alloyed with the anode current collector at least at part of the interface with the anode current collector, and
the electrolytic solution contains a derivative of cyclic carbonate having halogen atoms and a cyclic acid anhydride.

2. A battery comprising:
a cathode;
an anode; and
an electrolytic solution,
wherein the anode has an anode current collector and an anode active material layer formed on the anode current collector by at least one from the group consisting of vapor-phase deposition method, liquid-phase deposition method and firing method, and
the electrolytic solution contains a derivative of cyclic carbonate having halogen atoms and a cyclic acid anhydride.

3. The battery according to claim 2, wherein as the cyclic acid anhydride, at least one from the group consisting of succinic anhydride, glutaric anhydride, maleic anhydride, phthalic anhydride, 2-sulfobenzoic anhydride, citraconic anhydride, itaconic anhydride, diglycolic anhydride, hexafluoro glutaric anhydride, 3-fluoro phthalic anhydride, 4-fluoro phthalic anhydride, 3,6-epoxy-1,2,3,6-tetrahydro phthalic anhydride, 1,8-naphthalic anhydride, and 2,3-naphthalene carboxylic anhydride is contained.

4. The battery according to claim 2, wherein the content of the cyclic acid anhydride in the electrolytic solution is in the range from 0.1 wt % to 2.5 wt %.

5. The battery according to claim 2, wherein as the derivative of cyclic carbonate, at least one of 4-fluoro-1,3-dioxolane-2-one and 4-chloro-1,3-dioxolane-2-one is contained.

6. The battery according to claim 2, wherein the anode active material layer contains at least one of tin (Sn) and silicon (Si) as an element.
